(19) United States
(12) Patent Application Publication
(10) Pub. No.: US 2024/0016171 A1
(43) Pub. Date: Jan. 18, 2024

(54) Cannabinoid Infused Coffee

(71) Applicant: Justin Sutton, Pawleys Island, SC (US)

(72) Inventor: Justin Sutton, Pawleys Island, SC (US)

(21) Appl. No.: 18/217,909

(22) Filed: Jul. 3, 2023

Related U.S. Application Data
(60) Provisional application No. 63/358,144, filed on Jul. 3, 2022.

(51) Int. Cl. A23F 5/14; A23F 5/46

(52) U.S. Cl. CPC A23F 5/14; A23F 5/465

(57) ABSTRACT

A method of manufacture of cannabinoid infused coffee is disclosed. The method relates to manufacture of infused caffeinated beverages such as coffee and tea, typically coffee that are infused with chemically pure CBD. The method entails formation of chemically pure CBD isolate and infusing the isolate at elevated temperature into a caffeinated beverage such as coffee or tea, typically coffee.

### CROSS-REFERENCE TO RELATED APPLICATIONS

This application relates back to and claims priority to the provisional application U.S. 63/358,144 filed on Jul. 3, 2022.

### BACKGROUND OF THE INVENTION

Cannabis as a health supplement has been practiced for over 1,000 years. Traditionally cannabis is heated to release cannabinoids, primary tetrahydrocannabinol and cannabidiol. It is well known that cannabinoids offer many benefits to users, and there are a variety of methods to make cannabinoids available to the user. Recently, there has been a trend to enrich cannabinoids into beverages, such as coffee and tea. Consequently, the present invention provides an improved method for cannabinoid delivery into beverages.

### SUMMARY OF THE INVENTION

The following description is provided to enable any person skilled in the art to make and use the invention and sets forth the best modes contemplated by the inventor. For the purpose of this disclosure, CBD Isolate is defined as chemically pure cannabinoid (“CBD”) in crystalline form. Distilled oil is oleoresin of the cannabis plant containing 70% or more CBD by weight that has been chilled to −60 F to separate non-CBD particles from the oil.

The disclosed method relates to manufacture of infused caffeinated beverages such as coffee and tea, typically coffee that are infused with chemically pure CBD. The method entails formation of chemically pure CBD isolate and infusing the isolate at elevated temperature into a caffeinated beverage such as coffee or tea, typically coffee. The infused beverages may be substituted for chemical energy drinks. The infused beverages also may be flavored with vanilla and maple syrup.

### General Procedure For Manufacture Of Purified CBD Isolate

Add distilled oil to a mixing vessel such as stainless steel and heat to about 32° C. while stirring. Slowly add ethanol, typically room temperature ethanol, to the distilled oil while stirring to form a blend.

The blend is maintained at about −35° C. to precipitate 99.98% pure CBD isolate crystals in the mixing vessel. The CBD crystals are rinsed in chilled ethanol at about −35° C. to form colorless CBD crystals. The colorless CBD crystals are ground such as by mortar and pestle, manual grinder, pneumatic or electric grinder into a uniform CBD powder. The CBD powder is treated to a vacuum at room temperature for about one hour to about two hours to remove residual ethanol.

### General Procedure for Manufacture of CBD Isolate Infused Coffee

Mix high caffeine coffee with water, typically about 900 gms of ground high caffeine Arabica Coffee with about 16 liters water, and heat to about 150° F. to about 212° F., typically about 150° F. to about 180° F. to form hot coffee liquid.

Mix about 7 gms CBD isolate with about 136 ml PPG to form a water-soluble CBD isolate liquid. Typically, about 20 ml propylene glycol (“PPG”) is mixed with about one gm isolate.

Add about 140 ml of the CBD isolate liquid to about 16 liters of the hot coffee liquid to form a coffee blend and mix for about five min.

Continue heating the coffee blend to infuse the isolate into the coffee to form infused coffee. The infused coffee then may be chilled.

In some embodiments, coffee variations each contain 100 mg of CBD isolate per 300 mL of coffee.

In some embodiments, 2000 mg of isolate per 40 mL of warm propylene glycol are combined and heated until dissolved which results in 50 mg per 1 mL of solution.

### EXAMPLE 1: MANUFACTURE OF CHEMICALLY PURE CBD ISOLATE

1100 ml distilled oil is added to a stainless-steel mixing vessel and heated to 32 C while stirring.
100 ml room temperature ethanol is added to the distilled oil while stirring to form a blend. The temperature of the blend is maintained at 32° C. while stirring.

The blend then is cooled to −35° C. The blend is maintained at −35° C. to precipitate 99.98% pure CBD isolate crystals in the mixing vessel.

The CBD isolate crystals are treated with chilled ethanol at −35° C. to form colorless CBD crystals.

The colorless CBD crystals are then ground to form CBD ground powder. The ground CBD powder is then subjected to a vacuum at room temperature for two hours to remove residual ethanol.

### EXAMPLE 2: CBD ISOLATE INFUSED COFFEE

Mix 900 gms ground high caffeine Arabica Coffee with 16 liters water and heat to 150 of to form hot coffee liquid.

Mix one gm CBD isolate with 20 ml propylene glycol (“PPG”) to form CBD isolate liquid.

Add 140 ml of the CBD isolate liquid to 16 liters of the hot coffee liquid to form a coffee blend and stir for five min.

Continue heating the coffee blend for while stirring to infuse the isolate into the coffee to form infused coffee.

1. A method for manufacture of chemically pure CBD Isolate comprising, mixing distilled oil at about 32° C. with room temperature ethanol to form a blend, cooling the blend to about −35° C. to precipitate 99.98% pure CBD isolate crystals, treating the CBD isolate crystals with chilled ethanol at −35° C. to form colorless CBD crystals, grinding the colorless CBD crystals to form CBD powder, and treating the CBD powder to a vacuum to form chemically pure CBD Isolate.

2. A method for manufacture of CBD isolate infused coffee comprising, mixing coffee with water and heating to about 150° F. to form hot coffee liquid, mixing PPG and chemically pure CBD isolate to form a CBD isolate liquid, mixing the CBD isolate liquid with the hot coffee liquid to form a coffee blend, and heating the coffee blend to infuse the CBD isolate into the coffee to form infused coffee.

3. A coffee beverage comprising coffee infused with chemically pure CBD.
